(19) United States
(12) Patent Application Publication
(10) Pub. No.: US 2026/0012370 A1
(43) Pub. Date: Jan. 8, 2026

(54) DETECTION OF TRAFFIC FROM A RELAYED DEVICE IN A COMMUNICATIONS NETWORK

(71) Applicant: Telefonaktiebolaget LM Ericsson (publ), Stockholm (SE)

(72) Inventors: Gonzalo HERNANDEZ HARO, Madrid (ES); Miguel Angel MUÑOZ DE LA TORRE ALONSO, Madrid (ES)

(21) Appl. No.: 18/993,697

(22) PCT Filed: Sep. 22, 2022
(86) PCT No.: PCT/EP2022/076095

§ 371 Date: Jan. 13, 2025

(30) Foreign Application Priority Data
Jul. 12, 2022 (EP) 22382659.5

(51) Int. Cl. H04L 12/14

(52) U.S. Cl. CPC H04L 12/1403

(57) ABSTRACT

A method for detecting and handling traffic from relayed or tethered devices in a communications network. The method includes obtaining at a terminal device network address information for a relayed device; transmitting from the terminal device traffic received from the relayed device, wherein the network traffic includes the network address information; and determining that the traffic relates to the relayed device based on the network address information. In some embodiments, the method further includes receiving at the terminal device an indication that the network address information shall be obtained for the relayed devices connected to the terminal device. In some embodiments, the method further includes transmitting from the terminal device an indication of the capability of the terminal device to obtain the network address information for relayed devices.

### TECHNICAL FIELD

The present invention generally relates to traffic classification and management in mobile or communications network, and more specifically, the invention relates to the detection and handling of traffic from devices that are relayed by a User Equipment of the mobile or communications network.

### BACKGROUND

In 3GPP 5^{th} generation (5G) networks, the Access and Mobility Management Function (AMF) supports termination of NAS signalling, NAS ciphering & integrity protection, registration management, connection management, mobility management, access authentication and authorization, security context management, etc. The Policy Control Function (PCF) supports a unified policy framework to govern the network behaviour. Specifically, PCF provides PCC (Policy and Charging Control) rules to the PCEF (Policy and Charging Enforcement Function), i.e., the SMF/UPF that enforces policy and charging decisions according to provisioned PCC rules. The Session Management function (SMF) supports session establishment, modify and release, and policy related functionalities like termination of interfaces towards Policy control functions, Charging data collection, support of charging interfaces and control and coordination of charging data collection at UPF. The User Plane function (UPF) supports handling of user plane traffic, including packet inspection, packet routing and forwarding, traffic usage reporting, QoS handling for user plane (e.g., UL/DL rate enforcement).

It is possible for a User Equipment (UE) to act as relay for other devices. An example of this is tethering, which is the practice of sharing the internet connection of a UE with other connected UEs or user devices. Tethering creates a mobile hotspot in the UE that acts as a relay. Tethering enables UEs or user devices without a built-in mobile data plan to connect to the internet by means of connecting to the relay UE. Tethering is also more secure than using an public hotspot connection for a user device.

A problematic aspect is that when a UE acting as relay (e.g., in tethering) shares its connection with other devices (relayed devices), the UE uses its own IP range for the traffic of the tethering devices that is transmitted to the mobile network, and as a result it is not possible for the network operator to detect that the traffic is traffic of relayed devices by inspecting the IP information of the traffic, since all the traffic is behind the same IP addresses.

Network operators detect tethering using diverse mechanisms (e.g., OS fingerprinting), however, as traffic encryption is growing, and some advanced users hack the UE to avoid tethering detection on the network side, it is becoming more and more difficult for the network operators to detect tethering or traffic from relayed devices.

### SUMMARY

An object of the invention is to enable the detection and differentiated handling of traffic from relayed or tethered devices in a communications network.

A first aspect of the invention relates to a method performed by a terminal device for detecting and handling traffic from relayed or tethered devices in a communications network. The method comprises obtaining at a terminal device from a first network node network address information for a relayed device, wherein the terminal device acts as a relay for the relayed device; and transmitting from the terminal device toward a second network node network traffic received from the relayed device, wherein the network traffic includes the network address information. In some embodiments, the method further comprises receiving at the terminal device from the first network node an indication that the network address information shall be obtained for the relayed devices connected to the terminal device, particularly wherein the indication is transmitted during the attachment or registration of the terminal device with the communications network or during the establishment of a user session with the communications network; and initiating at the terminal device the obtaining of the network address information for the relayed devices connected to the terminal device based on the indication. In some embodiments, the method further comprises transmitting from the terminal device to the first network node an indication of the capability of the terminal device to obtain the network address information for relayed devices, particularly wherein the indication is transmitted during the attachment or registration of the terminal device with the communications network or during the establishment of a user session with the communications network. In some embodiments, the method further comprises transmitting from the terminal device to the first network node an indication to release the network address information related to the relayed device, particularly wherein the indication is transmitted responsive to the disconnection of the relayed device to the terminal device. In some embodiments, the obtaining of the network address information is performed in response to the connection of the relayed device to the terminal device. In some embodiments, the network address information is an IP address, an IP address range or an IP address prefix. In some embodiments, the network address information is included in the traffic of the relayed device as part of the source IP address information. In some embodiments, the relayed device is a tethered device connected to the terminal device. In some embodiments, the first network node is an Access and Mobility Management Function (AMF), the second network node is a User Plane Function (UPF), and the terminal device is a User Equipment (UE).

A second aspect of the invention relates to a method performed by a first network node for detecting and handling traffic from relayed or tethered devices in a communications network. The method comprises transmitting from a first network node to a terminal device network address information for a relayed device, wherein the terminal device acts as a relay for the relayed device. In some embodiments, the method further comprises transmitting from the first network node to the terminal device an indication that the network address information shall be obtained for the relayed devices connected to the terminal device, particularly wherein the indication is transmitted during the attachment or registration of the terminal device with the communications network or during the establishment of a user session with the communications network. In some embodiments, the method further comprises receiving at the first network node from the terminal device an indication of the capability of the terminal device to obtain the network address information for relayed devices, particularly wherein the indication is transmitted during the attachment or registration of the terminal device with the communications network or during the establishment of a user session with the communications network. In some embodiments, the method further comprises transmitting from the first network node to a third network node the indication of the capability of the terminal device to obtain the network address information for relayed devices, particularly wherein the indication is transmitted during the establishment of a user session with the communications network. In some embodiments, the method further comprises receiving at the first network node from the terminal device an indication to release the network address information related to the relayed device, particularly wherein the indication is transmitted responsive to the disconnection of the relayed device to the terminal device; and transmitting from the first network node to the third network node the indication to release the network address information related to the relayed device. In some embodiments, the transmitting of the network address information to the terminal device is performed in response to the connection of the relayed device to the terminal device. In some embodiments, the network address information is an IP address, an IP address range or an IP address prefix. In some embodiments, the network address information is included in the traffic of the relayed device as part of the source IP address information. In some embodiments, the relayed device is a tethered device connected to the terminal device. In some embodiments, the first network node is an Access and Mobility Management Function (AMF), the third network node is a Session Management Function (SMF), and the terminal device is a User Equipment (UE).

A third aspect of the invention relates to a method performed by a second network node for detecting and handling traffic from relayed or tethered devices in a communications network. The method comprises receiving at a second network node from a terminal device network traffic received from a relayed device, wherein the network traffic includes network address information, wherein a terminal device acts as a relay for the relayed device; and determining at the second network node that the traffic relates to the relayed device based on the network address information. In some embodiments, the method further comprises transmitting from the second network node to a third network node an indication of the support of the capability of detecting traffic of relayed devices based on the network address information. In some embodiments, the method further comprises receiving at the second network node from the third network node the network address information related to a relayed device, particularly wherein the network address information is included in an information element, and particularly wherein the network address information is determined at the third network node or received from the first network node. In some embodiments, the method further comprises receiving at the second network node from the third network node an indication to release the network address information related to the relayed device; and releasing at the second network node the network address information related to the relayed device for stopping the detection of traffic of the relayed device. In some embodiments, the network address information is an IP address, an IP address range or an IP address prefix. In some embodiments, the third network node transmits the network address information to the second network node in a framed-route or a framed-ipv6-route information element. In some embodiments, the third network node transmits the network address information to the second network node for at least one Packet Detection Rule (PDR). In some embodiments, the network address information is included in the traffic of the relayed device as part of the source IP address information. In some embodiments, the relayed device is a tethered device connected to the terminal device. In some embodiments, the second network node is a User Plane Function (UPF), the third network node is a Session Management Function (SMF), and the terminal device is a User Equipment (UE).

Other aspects of the invention relate to mobile network nodes, particularly a terminal device (101, 700), a second network node (103, 900), a first network node (106, 800), a third network node (107) configured to perform the respective methods as described herein. Other aspects of the invention relate to computer program and computer program products.

In some embodiments, the terminal device is a User Equipment (UE). In some embodiments, the second network node is a User Plane Function (UPF). In some embodiments, the first network node is an Access and Mobility Management Function (AMF). In some embodiments, the third network node is a Session Management Function (SMF).

Advantageously, the solution disclosed herein enables the UE acting as relay (e.g., hotspot) to request and acquire IP addresses/ranges/prefixes for its relayed (e.g., tethering) devices.

Further advantageously, the solution disclosed herein enables the UPF to identify/classify/differentiate the relayed (e.g., tethering) traffic and to apply the corresponding policies.

Further advantageously, the solution disclosed herein enables the network operators to define and apply different policy actions to the traffic of the relayed (e.g., tethering) devices.

Additional objectives, features and advantages of the concepts disclosed herein will be apparent from the following description, claims and drawings, or may be learned by practice of the described technologies and concepts as set forth herein.

### BRIEF DESCRIPTION OF THE DRAWINGS

In order to best describe the manner in which the disclosed concepts may be implemented, as well as define other objects, advantages and features of the disclosure, a more particular description is provided below and is illustrated in the appended drawings. Understanding that these drawings depict only exemplary embodiments of the invention and are not therefore to be considered to be limiting in scope, the examples will be described and explained with additional specificity and detail through the use of the accompanying drawings.

FIG. 1 illustrates an example networked system in accordance with particular embodiments of the solution described herein.

FIGS. 2A-2D illustrate an example signaling diagram showing a procedure according to particular embodiments of the solution described herein.

FIG. 3 illustrates an example flowchart showing a method performed by a UE according to particular embodiments of the solution described herein.

FIG. 4 illustrates an example flowchart showing a method performed by a mobile network node according to particular embodiments of the solution described herein.

FIG. 5 illustrates an example flowchart showing a method performed by a mobile network node according to particular embodiments of the solution described herein.

FIG. 6 illustrates an example block diagram of a UE configured in accordance with particular embodiments of the solution described herein.

FIG. 7 illustrates an example block diagram of a mobile network node configured in accordance with particular embodiments of the solution described herein.

FIG. 8 illustrates an example block diagram of a mobile network node configured in accordance with particular embodiments of the solution described herein.

### DETAILED DESCRIPTION

The invention will now be described in detail hereinafter with reference to the accompanying drawings, in which examples of embodiments or implementations of the invention are shown. The invention may, however, be embodied or implemented in many different forms and should not be construed as limited to the embodiments set forth herein. Rather, these embodiments are provided so that this disclosure will be thorough and complete, and will fully convey the scope of present invention to those skilled in the art. It should also be noted that these embodiments are not mutually exclusive. Components from one embodiment may be tacitly assumed to be present/used in another embodiment. These embodiments of the disclosed subject matter are presented as teaching examples and are not to be construed as limiting the scope of the disclosed subject matter. For example, certain details of the described embodiments may be modified, omitted, or expanded upon without departing from the scope of the described subject matter.

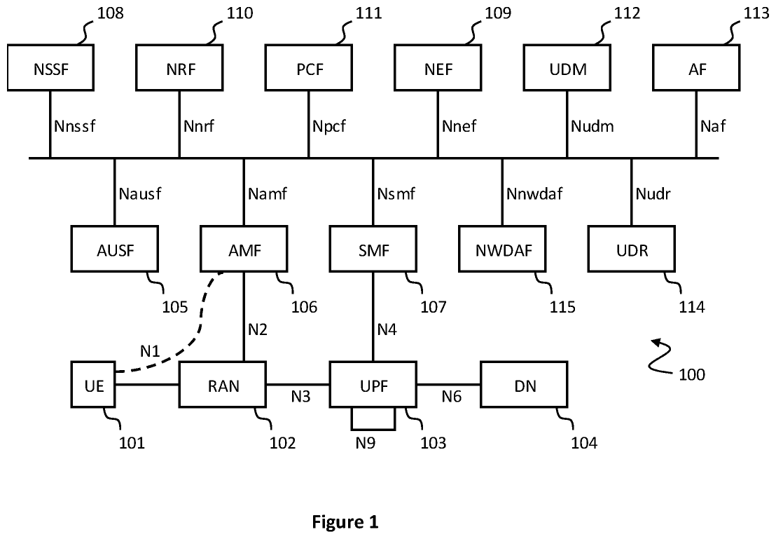

The example embodiments described herein arise in the context of a telecommunications network, including but not limited to a telecommunications network that conforms to and/or otherwise incorporates aspects of a fifth generation (5G) architecture. FIG. 1 is an example networked system 100 in accordance with example embodiments of the present disclosure. FIG. 1 specifically illustrates User Equipment (UE) 101, which may be in communication with a (Radio) Access Network (RAN) 102 and Access and Mobility Management Function (AMF) 106 and User Plane Function (UPF) 103. The AMF 106 may, in turn, be in communication with core network services including Session Management Function (SMF) 107 and Policy Control Function (PCF) 111. The core network services may also be in communication with an Application Server/Application Function (AS/AF) 113. Other networked services also include Network Slice Selection Function (NSSF) 108, Authentication Server Function (AUSF) 105, User Data Management (UDM) 112, Network Exposure Function (NEF) 109, Network Repository Function (NRF) 110 and Data Network (DN) 104. In some example implementations of embodiments of the present disclosure, each one of the entities in the networked system 100 are considered to be a Network Function (NF). One or more additional instances of the NFs may be incorporated into the networked system.

The solution described herein aims to enable the detection and differentiated handling of traffic from relayed or tethered devices in a communications network.

This disclosure provides a method for detecting and handling traffic from relayed or tethered devices in a communications network. The method comprises obtaining at a terminal device from a first network node network address information for a relayed device, wherein the terminal device acts as a relay for the relayed device; transmitting from the terminal device toward a second network node network traffic received from the relayed device, wherein the network traffic includes the network address information; and determining at the second network node that the traffic relates to the relayed device based on the network address information. In some embodiments, the method further comprises receiving at the terminal device from the first network node an indication that the network address information shall be obtained for the relayed devices connected to the terminal device, particularly wherein the indication is transmitted during the attachment or registration of the terminal device with the communications network or during the establishment of a user session with the communications network; and initiating at the terminal device the obtaining of the network address information for the relayed devices connected to the terminal device based on the indication. In some embodiments, the method further comprises transmitting from the terminal device to the first network node an indication of the capability of the terminal device to obtain the network address information for relayed devices, particularly wherein the indication is transmitted during the attachment or registration of the terminal device with the communications network or during the establishment of a user session with the communications network. In some embodiments, the method further comprises transmitting from the first network node to a third network node the indication of the capability of the terminal device to obtain the network address information for relayed devices, particularly wherein the indication is transmitted during the establishment of a user session with the communications network. In some embodiments, the method further comprises transmitting from the second network node to the third network node an indication of the support of the capability of detecting traffic of relayed devices based on the network address information; and selecting at the third network node the second network node for a terminal device that supports the capability of obtaining the network address information for relayed devices. In some embodiments, the method further comprises transmitting from the third network node to the second network node the network address information related to a relayed device, particularly wherein the network address information is included in an information element, and particularly wherein the network address information is determined at the third network node or received from the first network node. In some embodiments, the method further comprises transmitting from the terminal device to the first network node an indication to release the network address information related to the relayed device, particularly wherein the indication is transmitted responsive to the disconnection of the relayed device to the terminal device; transmitting from the first network node to the third network node the indication to release the network address information related to the relayed device; transmitting from the third network node to the second network node the indication to release the network address information related to the relayed device; and releasing at the second network node the network address information related to the relayed device for stopping the detection of traffic of the relayed device. In some embodiments, the obtaining of the network address information is performed in response to the connection of the relayed device to the terminal device. In some embodiments, the network address information is an IP address, an IP address range or an IP address prefix. In some embodiments, the third network node transmits the network address information to the second network node in a framed-route or a framed-ipv6-route information element. In some embodiments, the third network node transmits the network address information to the second network node for at least one Packet Detection Rule (PDR). In some embodiments, the network address information is included in the traffic of the relayed device as part of the source IP address information. In some embodiments, the relayed device is a tethered device connected to the terminal device. In some embodiments, the first network node is an Access and Mobility Management Function (AMF), the second network node is a User Plane Function (UPF), the third network node is a Session Management Function (SMF), and the terminal device is a User Equipment (UE).

This disclosure also provides mobile network nodes, particularly a terminal device (101, 600), a second network node (103, 800), a first network node (106, 700), a third network node (107, 00) configured to perform the respective methods as described herein. In some embodiments, the terminal device is a User Equipment (UE) 101. In some embodiments, the second network node is a User Plane Function (UPF) 103. In some embodiments, the first network node is an Access and Mobility Management Function (AMF) 106. In some embodiments, the third network node is a Session Management Function (SMF) 107.

This disclosure also provides the corresponding computer program and computer program products comprising code, for example in the form of a computer program, that when run on processing circuitry of the mobile network nodes causes the mobile network nodes to perform the disclosed methods.

Advantageously, the solution disclosed herein enables the UE acting as relay (e.g. hotspot) to request and acquire IP addresses/ranges/prefixes for its relayed (e.g. tethering) devices. Further advantageously, the solution disclosed herein enables the UPF to identify/classify/differentiate the relayed (e.g. tethering) traffic and to apply the corresponding policies.

Further advantageously, the solution disclosed herein enables the network operators to define and apply different policy actions to the traffic of the relayed (e.g. tethering) devices. The solution and the features comprised therein are further described in what follows.

This disclosure proposes a solution based on the request, acquisition, and release of IP addresses and/or ranges by a UE acting as a relay to be used as source address of the flows of the relayed (e.g., tethering) devices.

The UE acting as relay (e.g., hotspot), when capable, requests and acquires IP addresses and/or ranges for its relayed (e.g., tethering) devices and uses the acquired information as source address for the traffic of the relayed devices.

The proposed mechanism comprises the following steps:
In the PFCP Association procedure, the UPF reports to the SMF a new capability (e.g., “IP ranges acquisition for Relayed/Tethering Devices”) allowing the SMF to select a UPF supporting this capability on a per PFCP session basis.
Negotiation between the UE and Mobile network Operator (MNO) related to a new capability (e.g., “IP ranges acquisition for Relayed/Tethering Devices”). As an example, in the registration request from the UE to the MNO (AMF), the UE indicates a new capability (“IP ranges acquisition for Relayed/Tethering Devices”). If the MNO also supports the capability, it indicates that to the UE.
At PDU Session establishment, when relayed/tethering detection is required for a subscriber, the AMF indicates to the UE that IP ranges shall be requested when devices are connected by using a relayed/tethering connection.
During the PDU session, if the UE (acting as relay, e.g., hotspot) has received the above indication, when a new device requires a connection to the UE acting as relay (e.g., hotspot), the UE acting as relay (e.g., hotspot) shall request a new IPv4 or a IPv6 address or range. The UE will send all the relayed/tethering traffic from/to that device under the received IP range or address, e.g., using an IP address of the range as source IP address.
As the session is marked as relay/tethering capable, the SMF can provide to the UPF the IP address provided to the hotspot using the existing “framed-(ipv6)-route” Information Element (IE) or a dedicated IE.
The IE used above may be provided only for a set of PDRs for which the network operator wants to differentiate the relayed/tethering traffic.
The UPF uses the IP address/es received in the IE to identify the traffic generated by the relayed/tethering devices and apply a corresponding policy action.
When a relayed/tethering device disconnects form the hotspot connection, the UE acting as relay (e.g., hotspot) requests to release the IP address/IP address range to the AMF, in turn the AMF notifies the SMF and the SMF updates the UPF session to perform the IP address/IP address range release.

Hereinafter, drawings showing examples of embodiments of the solution are described in detail.

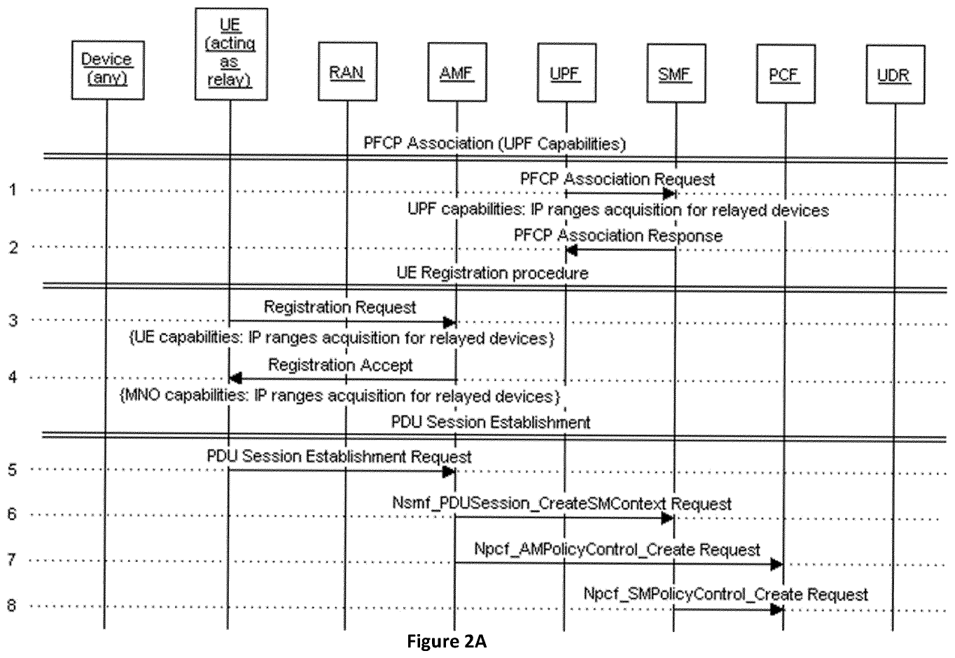

FIGS. 2A-2D represent a signaling diagram illustrating a procedure for detecting and handling traffic from relayed or tethered devices in a communications network. The procedure is performed by a terminal device (101, 600), a second network node (103, 800), a first network node (106, 700), and a third network node (107). In some embodiments, the terminal device is a User Equipment (UE) 101. In some embodiments, the second network node is a User Plane Function (UPF) 103. In some embodiments, the first network node is an Access and Mobility Management Function (AMF) 106. In some embodiments, the third network node is a Session Management Function (SMF) 107.

In steps 1 to 2) At PFCP Association procedure between the UPF and the SMF entities, the mechanism to report UPF capabilities includes a capability (e.g., “Support for IP address acquisition for relayed/tethering devices: IPAT, see table below in bold”). This allows the SMF to know which UPFs support this capability and thus can influence on UPF selection.

TABLE 1
UP Function Features

| Feature | | | |
|---|---|---|---|
| Octet / | | | |
| Bit | Feature | Interface | Description |
| 9/4 | IPAT | Sxb, Sxc, N4 | IP address acquisition for |
| | | | relayed devices is supported |
| | | | by the UP function. |

Feature Octet / Bit: The octet and bit number within the Supported-Features IE, e.g. “5 / 1”.
Feature: A short name that can be used to refer to the octet / bit and to the feature.
Interface: A list of applicable interfaces to the feature.
Description: A clear textual description of the feature.

In steps 3 and 4) The UE (acting as relay) indicates in the Registration Request to the AMF the capability (e.g., “IP ranges acquisition for Tethering Devices”). If MNO supports the capability, it indicates so to the UE in the Registration Accept message.

In steps 5 to 8) The UE triggers PDU Session Establishment procedure. As part of this procedure, the AMF creates the policy association with the PCF (Step 7) and the SMF creates the policy association with the PCF (Step 8).

In steps 9 and 10) The PCF retrieves from the UDR the subscriber policy profile (i.e., the policy data for this user's PDU session), which in this example includes a policy for relay/tethering control based on IP ranges acquisition for relayed/tethering devices.

In steps 11 and 12) The PCF generates PCC rules including the above tethering control policy based on IP ranges acquisition for relayed/tethering devices.

In steps 13 to 15) The SMF selects a UPF supporting the IP ranges acquisition for relayed/tethering devices capability and triggers PFCP Session Establishment procedure towards the UPF to indicate the PDRs and the corresponding enforcement actions (FARs, QERs, URRs, etc) for the PDU session.

In steps 16 and 17) The PCF sends an indication, towards the UE through the AMF, to request IP ranges for relayed/tethering devices, by triggering a Npcf AMPolicyControl Create Response message included in the Extended Protocol Configuration Options (ePCO).

In step 18) The AMF triggers a PDU Session Establishment Response including the above ePCO field (including the indication to request IP ranges for relayed/tethering devices).

In step 19) The UE stores the indication to request IP ranges for relayed/tethering devices.

In steps 20 and 21) The relayed/tethering device connects through the UE acting as relay (e.g., hotspot).

In steps 22 and 23) Based on the information stored in Step 19, the UE requests an IPV4 address/range/prefix or IPv6 address/range/prefix for the relayed/tethering device. The UE triggers a SMPolicyControl Request message including an indication to request the IPV4 or IPv6 address information for the relayed/tethering device.

In step 24) The AMF forwards the information in step 23 to the SMF.

In steps 25 and 26) The SMF allocates the IPv4 address/range/prefix or IPv6 address/range/prefix for the relayed/tethering device and triggers a SMPolicyControl Response message to the AMF including the allocated IPv4 address/range/prefix or IPv6 address/range/prefix for the relayed/tethering device.

In step 27) The AMF forwards the message in step 26 to the UE.

In step 28) The UE stores the allocated IPv4 address/range/prefix or IPv6 address/range/prefix for the relayed/tethered device.

In steps 28 and 29) In parallel to step 26, the SMF sends to the UPF the allocated IPv4 address/range/prefix or IPv6 address/range/prefix for the relayed/tethering device by triggering a PFCP Session Modification Request including the allocated IPV4 address/range/prefix or IPv6 address/range/prefix for the relayed/tethering device.

In steps 30 and 31) The UPF stores the IPV4 address/range/prefix or IPv6 address/range/prefix for the relayed/tethering device and answers back SMF indicating successful operation.

In steps 32 and 33) The relayed/tethering device starts sending application traffic through the UE acting as relay (e.g., hotspot).

In steps 34 and 35) Based on the information stored in step 28, the UE sets the source IP address for the traffic from relayed/tethered device.

In step 36) The UPF detects traffic from relayed/tethering device and applies the corresponding policy.

The solution described in this disclosure, may involve the Radio Access Network (RAN) in the communications between the UE acting as a relay and the communications network. The RAN may perform the functionality (or a subset of the functionality) of the AMF as described in this disclosure or may act as a transparent intermediary between the UE and the AMF.

Finally, the solution described in this disclosure does not only apply to 5G network architecture, but the same mechanisms can be applied to 4G, by replacing:
UDR by SPR.
PCF by PCRF.
SMF by PGW-C or TDF-C.
UPF by PGW-U or TDF-U

Hereinafter, flowcharts showing examples of embodiments of the solution are described in detail.

The embodiments correspond to methods performed by and involving a terminal device (101, 600), a second network node (103, 800), a first network node (106, 700), a third network node (107).

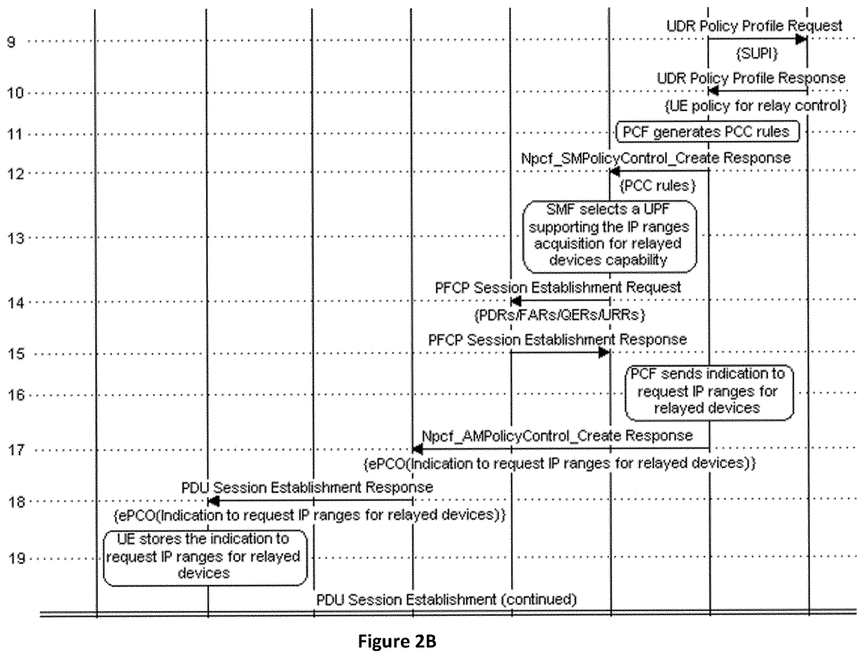

FIG. 3 is a flowchart illustrating a method performed by the terminal device for detecting and handling traffic from relayed or tethered devices in a communications network.

In step S-301, the terminal device transmits to the first network node an indication of the capability of the terminal device to obtain the network address information for relayed devices, particularly wherein the indication is transmitted during the attachment or registration of the terminal device with the communications network or during the establishment of a user session with the communications network.

In step S-302, the terminal device receives from the first network node an indication that the network address information shall be obtained for the relayed devices connected to the terminal device, particularly wherein the indication is transmitted during the attachment or registration of the terminal device with the communications network or during the establishment of a user session with the communications network.

In step S-303, the terminal device initiates the obtaining of the network address information for the relayed devices connected to the terminal device based on the indication.

In step S-304, the terminal device obtains from a first network node network address information for a relayed device, wherein the terminal device acts as a relay for the relayed device.

In step S-305, the terminal device transmits toward a second network node network traffic received from the relayed device, wherein the network traffic includes the network address information.

In step S-306, the terminal device transmits to the first network node an indication to release the network address information related to the relayed device, particularly wherein the indication is transmitted responsive to the disconnection of the relayed device to the terminal device.

In some embodiments, the obtaining of the network address information is performed in response to the connection of the relayed device to the terminal device.

In some embodiments, the network address information is an IP address, an IP address range or an IP address prefix.

In some embodiments, the network address information is included in the traffic of the relayed device as part of the source IP address information.

In some embodiments, the relayed device is a tethered device connected to the terminal device.

In some embodiments, the first network node is an Access and Mobility Management Function (AMF), the second network node is a User Plane Function (UPF), and the terminal device is a User Equipment (UE).

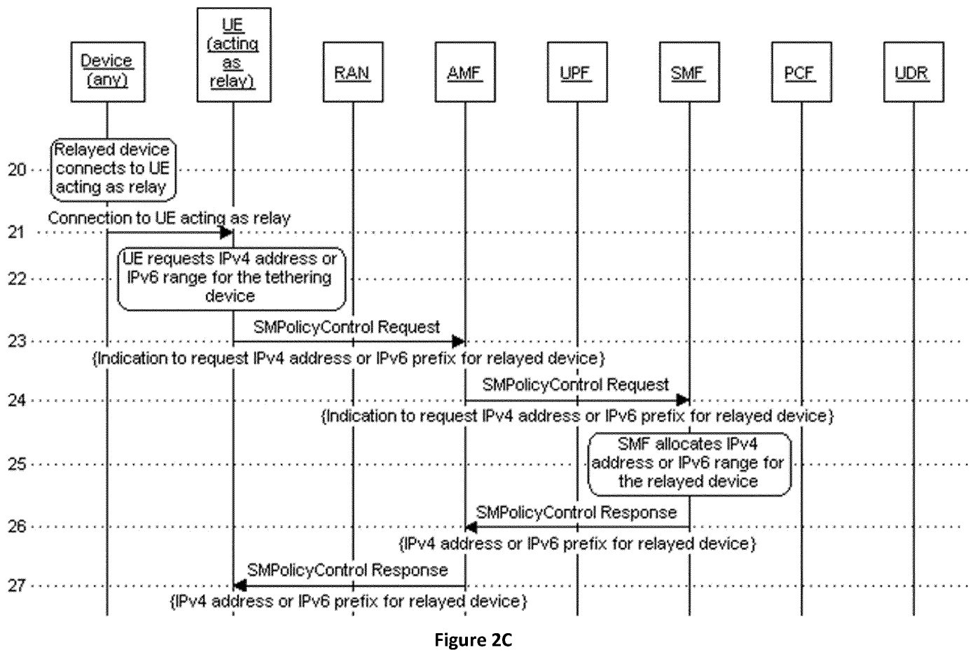

FIG. 4 is a flowchart illustrating a method performed by the first network node for detecting and handling traffic from relayed or tethered devices in a communications network.

In step S-401, the first network node receives from the terminal device an indication of the capability of the terminal device to obtain the network address information for relayed devices, particularly wherein the indication is transmitted during the attachment or registration of the terminal device with the communications network or during the establishment of a user session with the communications network.

In step S-402, the first network node transmits to a third network node the indication of the capability of the terminal device to obtain the network address information for relayed devices, particularly wherein the indication is transmitted during the establishment of a user session with the communications network.

In step S-403, the first network node transmits to the terminal device an indication that the network address information shall be obtained for the relayed devices connected to the terminal device, particularly wherein the indication is transmitted during the attachment or registration of the terminal device with the communications network or during the establishment of a user session with the communications network.

In step S-404, the first network node transmits to a terminal device network address information for a relayed device, wherein the terminal device acts as a relay for the relayed device.

In step S-405, the first network node receives from the terminal device an indication to release the network address information related to the relayed device, particularly wherein the indication is transmitted responsive to the disconnection of the relayed device to the terminal device.

In step S-406, the first network node transmits to the third network node the indication to release the network address information related to the relayed device.

In some embodiments, the transmitting of the network address information to the terminal device is performed in response to the connection of the relayed device to the terminal device.

In some embodiments, the network address information is an IP address, an IP address range or an IP address prefix.

In some embodiments, the network address information is included in the traffic of the relayed device as part of the source IP address information.

In some embodiments, the relayed device is a tethered device connected to the terminal device.

In some embodiments, the first network node is an Access and Mobility Management Function (AMF), the third network node is a Session Management Function (SMF), and the terminal device is a User Equipment (UE).

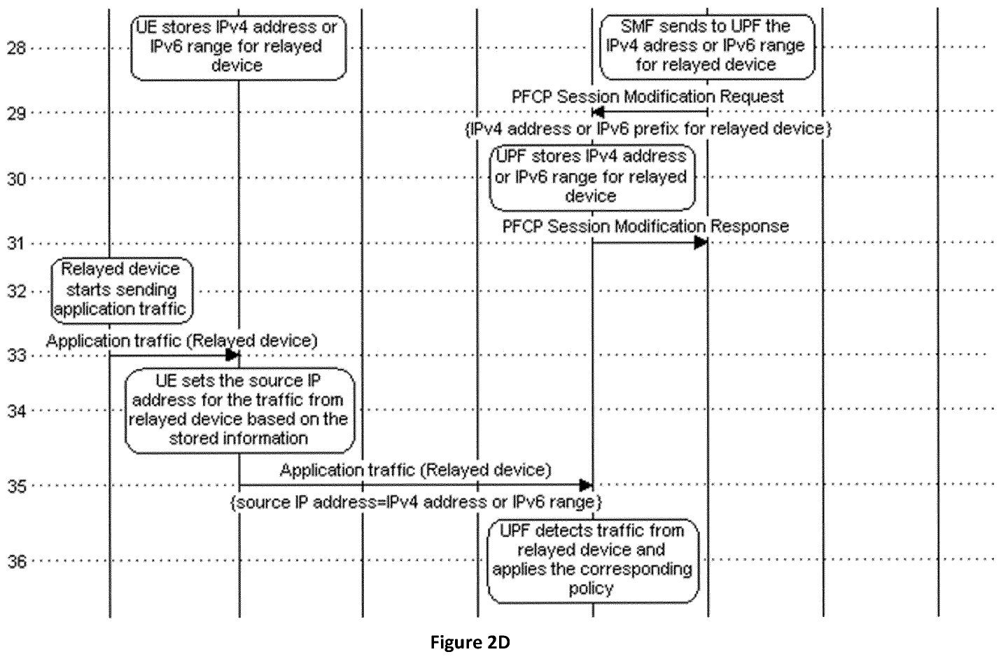

FIG. 5 is a flowchart illustrating a method performed by the second network node for detecting and handling traffic from relayed or tethered devices in a communications network.

In step S-501, the second network node transmits to a third network node an indication of the support of the capability of detecting traffic of relayed devices based on the network address information.

In step S-502, the second network node receives from the third network node the network address information related to a relayed device, particularly wherein the network address information is included in an information element, and particularly wherein the network address information is determined at the third network node or received from the first network node.

In step S-503, the second network node receives from a terminal device network traffic received from a relayed device, wherein the network traffic includes network address information, wherein a terminal device acts as a relay for the relayed device.

In step S-504, the second network node determines that the traffic relates to the relayed device based on the network address information.

In step S-505, the second network node receives from the third network node an indication to release the network address information related to the relayed device.

In step S-506, the second network node releases the network address information related to the relayed device for stopping the detection of traffic of the relayed device.

In some embodiments, the network address information is an IP address, an IP address range or an IP address prefix.

In some embodiments, the third network node transmits the network address information to the second network node in a framed-route or a framed-ipv6-route information element.

In some embodiments, the third network node transmits the network address information to the second network node for at least one Packet Detection Rule (PDR).

In some embodiments, the network address information is included in the traffic of the relayed device as part of the source IP address information.

In some embodiments, the relayed device is a tethered device connected to the terminal device.

In some embodiments, the second network node is a User Plane Function (UPF), the third network node is a Session Management Function (SMF), and the terminal device is a User Equipment (UE).

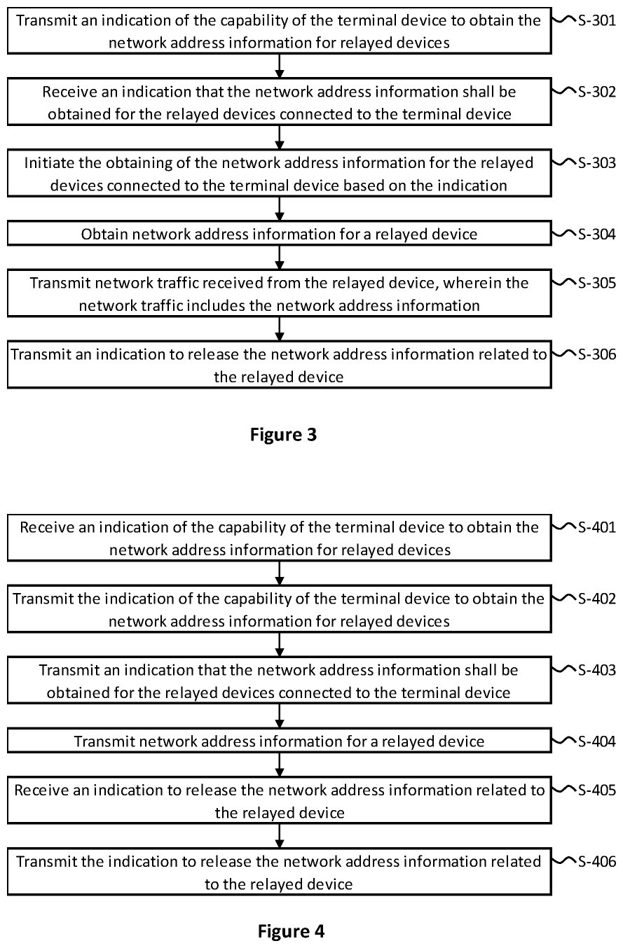

FIG. 6 is a block diagram illustrating elements of a User Equipment (UE) 600 (also referred to as a communication device, a mobile terminal, a mobile communication terminal, a wireless device, a wireless communication device, a wireless terminal, mobile device, a wireless communication terminal, a user equipment node/terminal/device, etc.) configured to provide wireless communication according to embodiments of the disclosure. As shown, communication device UE may include an antenna 607, and transceiver circuitry 601 (also referred to as a transceiver) including a transmitter and a receiver configured to provide uplink and downlink radio communications with a base station(s) (also referred to as a RAN node) of a radio access network. The UE may also include processing circuitry 603 (also referred to as a processor) coupled to the transceiver circuitry, and memory circuitry 605 (also referred to as memory, e.g. corresponding to device readable medium) coupled to the processing circuitry. The memory circuitry 605 may include computer readable program code, such as application client 609, that when executed by the processing circuitry 603 causes the processing circuitry to perform operations according to embodiments disclosed herein. According to other embodiments, processing circuitry 603 may be defined to include memory so that separate memory circuitry is not required. The UE 600 may also include an interface (such as a user interface) coupled with processing circuitry 603, and/or the UE may be incorporated in a vehicle. As discussed herein, operations of the UE may be performed by processing circuitry 603 and/or transceiver circuitry 601. For example, processing circuitry 603 may control transceiver circuitry 601 to transmit communications through transceiver circuitry 601 over a radio interface to a radio access network node (also referred to as a base station) and/or to receive communications through transceiver circuitry 601 from a RAN node over a radio interface. Moreover, modules may be stored in memory circuitry 605, and these modules may provide instructions so that when instructions of a module are executed by processing circuitry 603, processing circuitry 603 performs respective operations (e.g., the operations disclosed herein with respect to the example embodiments relating to the UE).

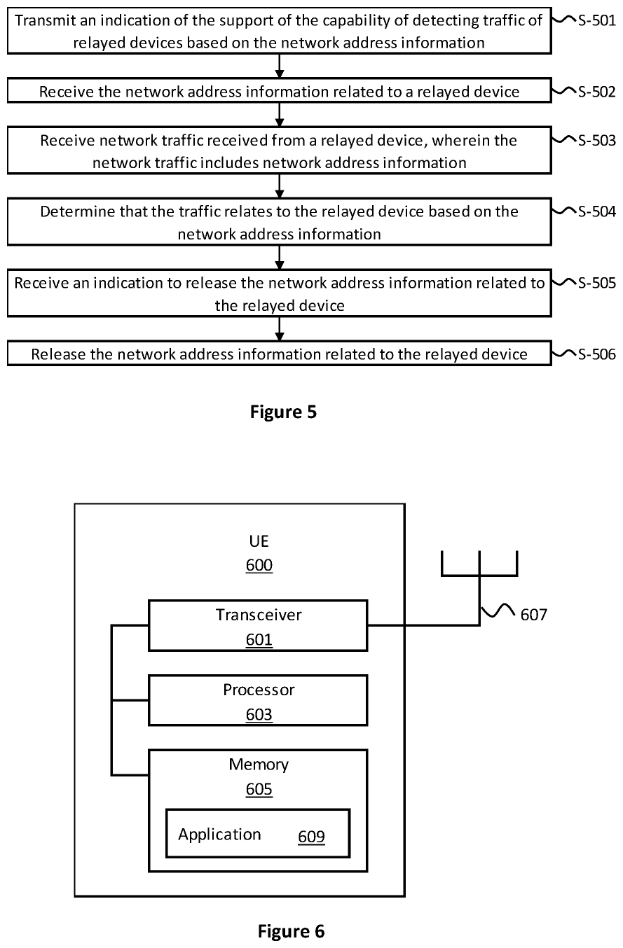

FIG. 7 is a block diagram illustrating elements of a mobile network node 700 of a mobile communications network. In some embodiments, the mobile network node 700 is an AMF 106. As shown, the mobile network node may include network interface circuitry 701 (also referred to as a network interface) configured to provide communications with other nodes of the core network and/or the network. The mobile network node may also include a processing circuitry 702 (also referred to as a processor) coupled to the network interface circuitry, and memory circuitry 703 (also referred to as memory) coupled to the processing circuitry. The memory circuitry 703 may include computer readable program code that when executed by the processing circuitry 702 causes the processing circuitry to perform operations according to embodiments disclosed herein. According to other embodiments, processing circuitry 702 may be defined to include memory so that a separate memory circuitry is not required. As discussed herein, operations of the mobile network node may be performed by processing circuitry 702 and/or network interface circuitry 701. For example, processing circuitry 702 may control network interface circuitry 701 to transmit communications through network interface circuitry 701 to one or more other network nodes and/or to receive communications through network interface circuitry from one or more other network nodes. Moreover, modules may be stored in memory 703, and these modules may provide instructions so that when instructions of a module are executed by processing circuitry 702, processing circuitry 702 performs respective operations (e.g., operations discussed below with respect to Example Embodiments relating to core network nodes).

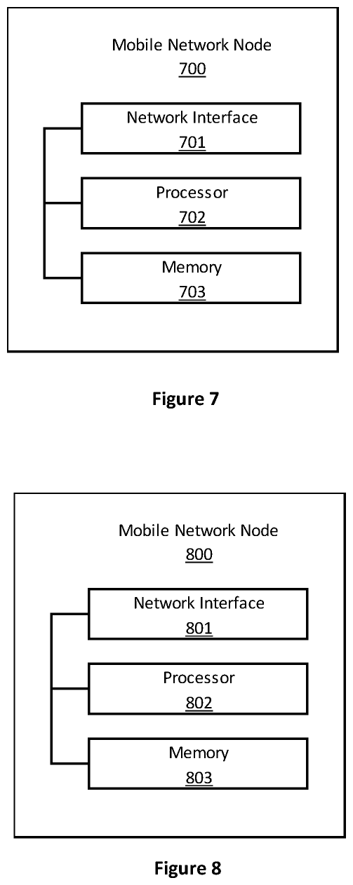

FIG. 8 is a block diagram illustrating elements of a mobile network node 800 of a mobile communications network. In some embodiments, the mobile network node 800 is a UPF 103. As shown, the mobile network node may include network interface circuitry 801 (also referred to as a network interface) configured to provide communications with other nodes of the core network and/or the network. The mobile network node may also include a processing circuitry 802 (also referred to as a processor) coupled to the network interface circuitry, and memory circuitry 803 (also referred to as memory) coupled to the processing circuitry. The memory circuitry 803 may include computer readable program code that when executed by the processing circuitry 802 causes the processing circuitry to perform operations according to embodiments disclosed herein. According to other embodiments, processing circuitry 802 may be defined to include memory so that a separate memory circuitry is not required. As discussed herein, operations of the mobile network node may be performed by processing circuitry 802 and/or network interface circuitry 801. For example, processing circuitry 802 may control network interface circuitry 801 to transmit communications through network interface circuitry 801 to one or more other network nodes and/or to receive communications through network interface circuitry from one or more other network nodes. Moreover, modules may be stored in memory 803, and these modules may provide instructions so that when instructions of a module are executed by processing circuitry 802, processing circuitry 802 performs respective operations (e.g., operations discussed below with respect to Example Embodiments relating to core network nodes).

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such tangible computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the tangible computer-readable media.

Computer-executable instructions include, for example, instructions and data which cause a general purpose computer, special purpose computer, or special purpose processing device to perform a certain function or group of functions. Computer-executable instructions also include program modules that are executed by computers in standalone or network environments. Generally, program modules include routines, programs, objects, components, and data structures that perform particular tasks or implement particular abstract data types. Computer executable instructions, associated data structures, and program modules represent examples of the program code means for executing steps of the methods disclosed herein. The particular sequence of such executable instructions or associated data structures represent examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Communication at various stages of the described system can be performed through a local area network, a token ring network, the Internet, a corporate intranet, 802.11 series wireless signals, fiber-optic network, radio or microwave transmission, etc. Although the underlying communication technology may change, the fundamental principles described herein are still applicable.

The various embodiments described above are provided by way of illustration only and should not be construed to limit the invention. For example, the principles herein may be applied to any remotely controlled device. Further, those of skill in the art will recognize that communication between the remote the remotely controlled device need not be limited to communication over a local area network but can include communication over infrared channels, Bluetooth or any other suitable communication interface. Those skilled in the art will readily recognize various modifications and changes that may be made to the present invention without following the example embodiments and applications illustrated and described herein, and without departing from the scope of the present disclosure.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and “comprising,” when used in this specification, specify the presence of stated features, integers, steps, operations, elements, or components, and combinations thereof, but do not preclude the presence or addition of one or more other features, integers, steps, operations, elements, or components, and combinations thereof. Further, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

1-14. (canceled)

15. A method performed by a terminal device for detecting and handling traffic from relayed or tethered devices in a communications network, the method comprising:
obtaining at a terminal device from a first network node network address information for a relayed device, wherein the terminal device acts as a relay for the relayed device; and
transmitting from the terminal device toward a second network node network traffic received from the relayed device, wherein the network traffic includes the network address information
wherein the network address information is an IP address, an IP address range or an IP address prefix.

16. The method of claim 15, further comprising:
receiving at the terminal device from the first network node an indication that the network address information shall be obtained for the relayed devices connected to the terminal device, particularly wherein the indication is transmitted during the attachment or registration of the terminal device with the communications network or during the establishment of a user session with the communications network; and
initiating at the terminal device the obtaining of the network address information for the relayed devices connected to the terminal device based on the indication.

17. The method of claim 15, further comprising:
transmitting from the terminal device to the first network node an indication of the capability of the terminal device to obtain the network address information for relayed devices, particularly wherein the indication is transmitted during the attachment or registration of the terminal device with the communications network or during the establishment of a user session with the communications network.

18. The method of claim 15, further comprising:
transmitting from the terminal device to the first network node an indication to release the network address information related to the relayed device, particularly wherein the indication is transmitted responsive to the disconnection of the relayed device to the terminal device.

19. The method of claim 15, wherein the obtaining of the network address information is performed in response to the connection of the relayed device to the terminal device.

20-21. (canceled)

22. The method of claim 15, wherein the relayed device is a tethered device connected to the terminal device.

23. The method of claim 15, wherein the first network node is an Access and Mobility Management Function, AMF, the second network node is a User Plane Function, UPF, and the terminal device is a User Equipment, UE.

24. A method performed by a first network node for detecting and handling traffic from relayed or tethered devices in a communications network, the method comprising:
transmitting from a first network node to a terminal device network address information for a relayed device, wherein the terminal device acts as a relay for the relayed device
wherein the network address information is an IP address, an IP address range or an IP address prefix.

25. The method of claim 24, further comprising:
transmitting from the first network node to the terminal device an indication that the network address information shall be obtained for the relayed devices connected to the terminal device, particularly wherein the indication is transmitted during the attachment or registration of the terminal device with the communications network or during the establishment of a user session with the communications network.

26. The method of claim 24, further comprising:
receiving at the first network node from the terminal device an indication of the capability of the terminal device to obtain the network address information for relayed devices, particularly wherein the indication is transmitted during the attachment or registration of the terminal device with the communications network or during the establishment of a user session with the communications network; and
transmitting from the first network node to a third network node the indication of the capability of the terminal device to obtain the network address information for relayed devices, particularly wherein the indication is transmitted during the establishment of a user session with the communications network.

27. (canceled)

28. The method of claim 24, further comprising:
receiving at the first network node from the terminal device an indication to release the network address information related to the relayed device, particularly wherein the indication is transmitted responsive to the disconnection of the relayed device to the terminal device; and
transmitting from the first network node to the third network node the indication to release the network address information related to the relayed device.

29-31. (canceled)

32. The method of claim 24, wherein the relayed device is a tethered device connected to the terminal device.

33. The method of claim 24, wherein the first network node is an Access and Mobility Management Function, AMF, the third network node is a Session Management Function, SMF, and the terminal device is a User Equipment, UE.

34-43. (canceled)

44. An apparatus for detecting and handling traffic from relayed or tethered devices in a communications network, the apparatus comprising a processor and a memory, the memory containing instructions executable by the processor such that the apparatus is operable to perform operations comprising:
obtain at a terminal device from a first network node network address information for a relayed device, wherein the terminal device acts as a relay for the relayed device; and
transmit from the terminal device toward a second network node network traffic received from the relayed device, wherein the network traffic includes the network address information
wherein the network address information is an IP address, an IP address range or an IP address prefix.

45. An apparatus for detecting and handling traffic from relayed or tethered devices in a communications network, the apparatus comprising a processor and a memory, the memory containing instructions executable by the processor such that the apparatus is operable to perform operations comprising:
transmit from a first network node to a terminal device network address information for a relayed device, wherein the terminal device acts as a relay for the relayed device
wherein the network address information is an IP address, an IP address range or an IP address prefix.

46-50. (canceled)
